(19) United States
(12) Patent Application Publication
(10) Pub. No.: US 2013/0236645 A1
(43) Pub. Date: Sep. 12, 2013

(54) METHOD FOR LOCALLY FORMING SMOOTH SURFACE ON FROSTED GLASS

(71) Applicant: LIEFCO OPTICAL LTD., Taichung City (TW)

(72) Inventors: Chin-Lung CHANG, Taichung City (TW); Jian-Feng LI, Taichung City (TW); Chia-Hsin CHANG, Taichung City (TW)

(73) Assignee: LIEFCO OPTICAL LTD., Taichung City (TW)

(21) Appl. No.: 13/785,728

(22) Filed: Mar. 5, 2013

(30) Foreign Application Priority Data
Mar. 6, 2012 (TW) 101107551

(51) Int. Cl. B05D 3/00

(52) U.S. Cl. CPC B05D 3/00
USPC 427/299

(57) ABSTRACT

A method for locally forming a smooth surface on frosted glass includes steps of: a) preparing a piece of frosted glass; b) locally coating the frosted glass with a sealant; and c) such forming the sealant that has a smooth surface. The smooth surface of the frosted glass allows a video camera to capture clear images therethrough so as to prevent blurred images caused by micro-roughness on a surface of the frosted glass.

### BACKGROUND OF THE INVENTION

1. Technical Field

The present invention relates to protective glass for screens of portable electronic devices, and more particularly, to frosted glass that has micro-roughness on its surface for preventing undesirable fingerprint transfer and light reflection and has a local area formed with a smooth surface through which a camera lens can capture images clearly.

2. Description of Related Art

The display screens, particularly the touch screens of portable electronic devices such as mobile phones, digital cameras, PDAs, tablet computers or notebook computers are typically protected by tempered glass from scratches or over-pressing damages. Considering that tempered glass with a smooth surface can accumulate fingerprints and desirably hinder users' operating the devices by reflecting incident light, some manufacturers frost tempered glass by forming micro-roughness on the surface of the latter, so as to successfully solve the problems about fingerprints and light reflection. Most existing portable electronic devices, however, adopt an integrated structure for protecting the display screen and the camera lens, which is made by covering the display screen and the camera lens with a single piece of frosted glass. In this case, the micro-roughness on the surface of the frosted glass can scatter incident light and hinder the camera lens from taking clear images.

A conventional approach to allowing clear images, as shown in FIG. 1 and FIG. 2, involves providing a through hole 2 on the frosted glass 1 so that the through hole 2 is aligned with and allows the camera lens 3 to capture clear image therethrough. However, since the tempered glass is hardened, the difficult work of forming the through hole on the glass can complicate the processing and increase the overall manufacturing costs. Additionally, as such a through hole is usually located near an edge of the glass, poor drilling can even make the glass crack and become defective.

### SUMMARY OF THE INVENTION

According to the present invention, a method for locally forming a smooth surface on frosted glass primarily comprises the following steps:

a) preparing a piece of frosted glass;

b) locally coating the frosted glass with a sealant; and

c) such forming the sealant that has a smooth surface.

The primary objective of the present invention is to provide a method that locally forms the smooth surface on the frosted glass, which allows a video camera to capture clear images therethrough, so as to prevent blurred images caused by micro-roughness on a surface of the frosted glass.

### BRIEF DESCRIPTION OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 is a perspective view of a conventional portable electronic device;

FIG. 2 is a partial, cross-sectional view of the conventional portable electronic device;

FIG. 3 is a perspective view of a portable electronic device made using the method of the present invention;

FIG. 4A and FIG. 4B are schematic drawings illustrating the method of the present invention;

FIG. 4C is a partial, cross-sectional view of the portable electronic device made using the method of the present invention;

FIG. 5 is a flowchart of the method of the present invention; and

FIG. 6 is a partial, cross-sectional view of a portable electronic device made using the method according to another embodiment of the present invention;

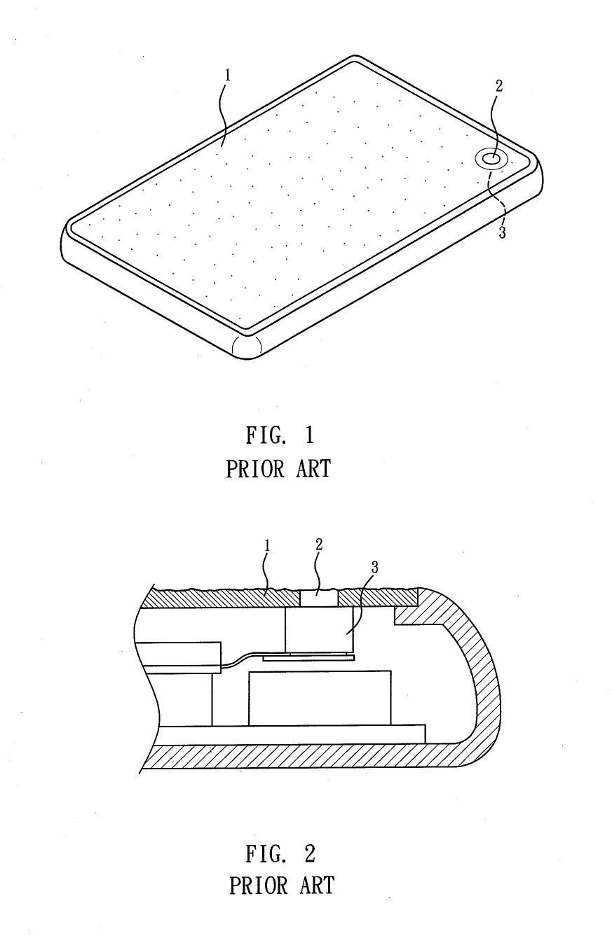

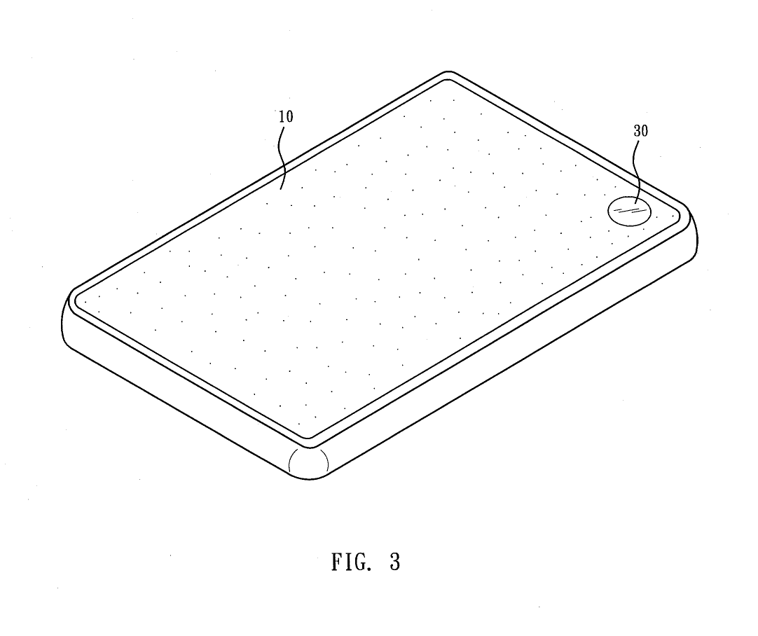

### DETAILED DESCRIPTION OF THE INVENTION

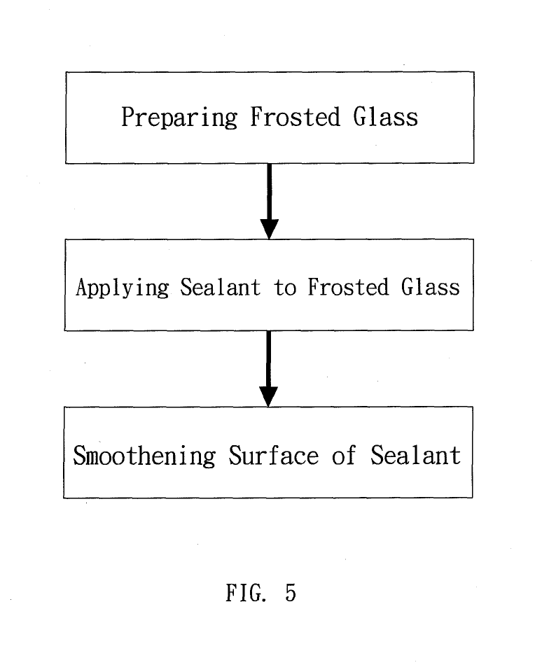

FIG. 3 through FIG. 5 illustrate a method for locally forming a smooth surface on frosted glass according to one embodiment of the present invention, which comprising the following steps:

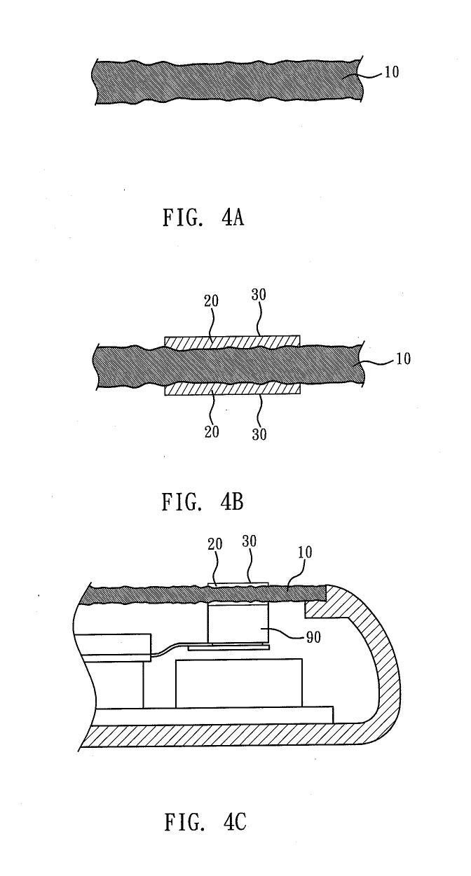

a) preparing a piece of frosted glass 10, wherein the frosted glass 10 is frosted because at least one surface thereof is formed with micro-roughness, as shown in FIG. 4A;

b) locally coating the frosted glass 10 with a sealant 20, such that the sealant 20 fill in at least a part of depressed areas of the micro-roughness on the surface of the frosted glass 10; and

c) such forming the sealant 20 that provides a smooth surface 30 on the frosted glass 10.

Therein, the sealant 20 may be transparent ink, transmitting glue, previous-to-light plastic or glass. For example, in the embodiment where the sealant 20 is transparent ink, the ink may be coated at where the smooth surface 30 is to be formed through printing and dried to provide a smooth surface 30.

As shown in FIG. 4C, when the frosted glass 10 is assembled to a portable electronic device, the smooth surface 30 is aligned with a camera lens 90, so that incoming light is allowed to directly pass through the smooth surface 30 and reach the camera lens 90 without being scattered by the micro-roughness of the frosted glass 10, and the camera lens 90 can take clear images.

In an embodiment where the present invention is applied to frosted glass 10 with both sides having micro-roughness, the sealant 20 may be applied to the both sides of the frosted glass 10 so as to form smooth surfaces 30 at the two sides of the frosted glass 10. In an embodiment where the present invention is applied to frosted glass 10 with only one side having micro-roughness, only the side with the micro-roughness is coated with the sealant 20 and then has the local smooth surface 30.

In other embodiments, the sealant 20 may be realized as plastic or glass in a melted phase, so that when the melt plastic or glass is cooled and cured, the smooth surface 30 is formed on the frosted glass 10. Therein, the transparent ink, transmitting glue, previous-to-light plastic or glass may be selected to have its light penetration rate and refractive index identical or similar to those of the frosted glass 10, so as to enhance the effects of locally leveling the micro-roughness on the frosted glass 10 and preventing blurred images, as provided by the present invention.

According to the present invention, by simply applying the sealant 20 to the surface of the frosted glass 10 through printing, coating or adhering, a local smooth surface can be provided, so the disclosed method is advantageous for it allows simple processing, low manufacturing costs and a good light-transmission effect.

Moreover, for further protecting the smooth surface 30 made of the sealant 20, the step b) further comprises a step of providing a protection layer 40 over the sealant 20. This protection layer 40 is configured to secure the sealant 20 from getting damaged or coming off upon application of excessive external forces. The protection layer 40 may be made of transmitting film, previous-to-light plastic or previous-to-light glass.

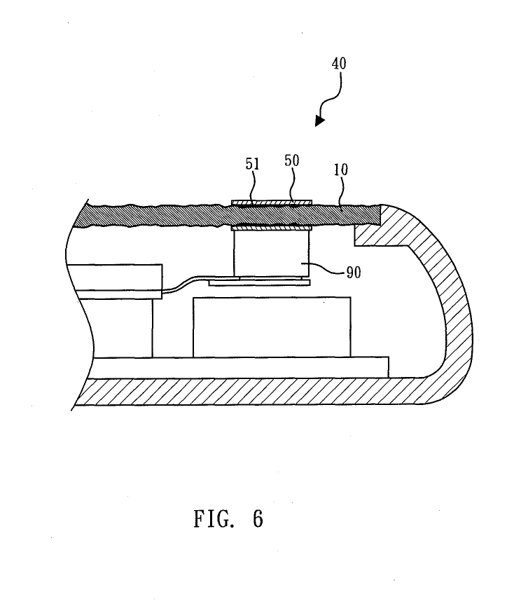

In addition, as shown in FIG. 6, the application of the sealant 20 and the formation of the protection layer 40 may be accomplished in a single step. In an embodiment where a transmitting film 50 is used, the transmitting film 50 includes an adhesive layer 51 that can attach the transmitting film 50 to the surface of the frosted glass 10. The adhesive layer 51 itself may be previous to light, so that the adhesive layer 51 can function as the sealant 20, and the transmitting film 50 can act as the protection layer 40. When the transmitting film 50 is attached to the frosted glass 10, the adhesive layer 51 can level up the micro-roughness thereon and prevent the micro-roughness from causing light scattering.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A method for locally forming a smooth surface on frosted glass, the method comprising steps of:
a) preparing a piece of frosted glass;
b) locally coating the frosted glass with a sealant; and
c) such forming the sealant that has a smooth surface.

2. The method of claim 1, wherein the sealant is made of at least one of transparent ink, transmitting glue, previous-to-light plastic and glass.

3. The method of claim 1, wherein the step b) further comprises depositing a protection layer on a surface of the sealant.

4. The method of claim 3, wherein the protection layer is made of at least one of transmitting film, previous-to-light plastic and previous-to-light glass.

5. The method of claim 1, wherein in the step b), the sealant is pre-coated on a protection layer and combined with a local area of the frosted glass.

6. The method of claim 5, wherein the sealant is an adhesive layer that is previous to light.

7. The method of claim 6, wherein the protection layer is made of at least one of transmitting film, previous-to-light plastic and previous-to-light glass.
